(19) United States
(12) Patent Application Publication
(10) Pub. No.: US 2025/0266857 A1
(43) Pub. Date: Aug. 21, 2025

(54) Hi-Def Radio Strap System

(71) Applicant: Christopher W Parrish, Middletown, IN (US)

(72) Inventor: Christopher W Parrish, Middletown, IN (US)

(21) Appl. No.: 19/055,492

(22) Filed: Feb. 17, 2025

Related U.S. Application Data
(60) Provisional application No. 63/555,051, filed on Feb. 18, 2024.

(51) Int. Cl. H04B 1/3888

(52) U.S. Cl. CPC H04B 1/3888

(57) ABSTRACT

The Hi-Def Radio Strap System is a portable radio carrying system attached to a main strap and manufactured with abrasion resistant and fire-retardant materials. The radio bucket is made of fabric and formed into a shape suitable for insertion and protection of a portable radio; attachment hardware secures the shape and permits for attaching of other accessories to the radio strap and bucket; this system surrounds the portable radio to prevent radio from being easily dislodged from the radio bucket. The radio strap system includes a radio tail connected to the main radio strap by a belt buckle style attachment member. This allows for adjustability of the length of the radio strap plus provides an attachment member at either end of the radio strap as a rotatable, quick-release design.

### CROSS-REFERENCE TO RELATED APPLICATIONS

This application claims the benefit of United States Provisional Patent Application with Ser. No. 63/555,051 filed Feb. 18, 2023, by Christopher W. Parrish. The provisional application is entitled “Hi-Def Radio Strap.”

### FIELD OF INVENTION

The present invention relates to the field of first responders, public servants or any profession or individual utilizing a portable radio with a corded or cordless microphone. Specifically, the present invention relates to first responders carrying two-way portable radios. The present disclosure relates generally to communication systems. More particularly, the present disclosure relates to communication systems with body-worn radios for immediate communications during emergency situations.

### FEDERALLY SPONSORED RESEARCH

None.

### SEQUENCE LISTING OR PROGRAM

None.

### BACKGROUND-FIELD OF INVENTION and PRIOR ART

As far as known, there are no other Hi-Def Radio Strap System such as revealed in this application. The present invention relates to mobile communication devices and, in particular, to a portable radio that has components distributed about a user's body, utilizing the body as a vehicle to carry the radio. People who serve the public such as police officers, fire fighters, utilities personnel and the like, require portable mobile communication devices to perform their job. Although existing portable radio technology is smaller and more convenient than in the past, existing technology suffers from several drawbacks. For example, as duty shifts increase to twelve hours and longer, battery power must be increased correspondingly to enable lasting communication devices. On current radios, however, added battery power is typically achieved using a cumbersome and unbalanced mass attached to the radio itself. Moreover, when a radio is worn on the user's hip, the user's body can get in the way of the antenna and interfere with the signal. Some radios attach the antenna to the shoulder speaker mic, but since the antenna projects upward and must be worn outside the clothing, it can get in the way or get caught. Furthermore, radios that are worn on a user's hip can be difficult to access quickly and are far away from the user's ear, sometimes resulting in missed communications.

First responders are among numerous professions and industries that rely heavily on two-way radios to effectively perform multiple functions of their job. The two-way radio (referred to as radio throughout) offers the individual the ability to communicate with other individuals in the same vicinity or those in remote locations that can offer them additional resources.

The use of a radio in many of these environments and situations require additional protection from day-to-day job functions. This additional protection comes in the form of protecting the radio from damage, entanglement, heat, and liquid. It also requires protection of the microphone cord from the previously mentioned potential negative effects on the radio and accessories.

The use of a radio strap outside of protection to the radio itself is identification. First responders utilize as many opportunities as possible to identify their unit, name, apparatus, team, etc. on their gear. Prior art does not offer customization ability to various aspects of the radio strap for the individual wearing to identify any aspect of them or their role. Therefore, what is needed are techniques that overcome the above-mentioned disadvantages.

### Problems Solved

Many problems and irritations are solved with the advent of the Hi-Def Radio Strap System. The advantages described below help the firefighters, first responders, defense personnel and others always keep aware where their radio and other communications are located.

### PRIOR ART

A novelty search was completed for a Hi-Def Radio Strap System. The search revealed the following: A. Prior art U.S. Pat. No. 3,868,573 by Holcomb et al issued in 1975 for a Shoulder holster communication device. This invention is a special shoulder holster body transceiver to be worn by police agents, or the like, incorporating independent receiver and transmitter means with appropriate interconnection for jointly transmitting or receiving and incorporating means for inconspicuous switching activation, as well as confidential receiving, including special switching activated by the movement of an arm.

B. U.S. Pat. No. 5,884,198 by Kese in 1999 a Body conformal portable radio and method of constructing the same. The components of a portable radio are distributed over a user's body to utilize the user's body as a vehicle for carrying the radio. A patch antenna mounted across a user's shoulder improves the user's ability to receive and transmit by minimizing body shielding effects. A control unit including a talk button, display, key pad and speaker is mountable to the user's other shoulder in close proximity to a user's ear and mouth for faster and more efficient communication. The power supply includes a plurality of battery packs that are mountable about the user's waist. The radio components are thus positioned to optimize their use while efficiently and comfortably utilizing the user's body to support the radio.

C. U.S. Pat. No. 6,375,056 by Henri issued in 2002 for an Over the shoulder holster belt. A holster belt for frictionally fitting over a shoulder and against the chest and back of an individual, said holster belt having: an elongated elastic band having releasable hooking first and second clamp buckles at its opposite ends for attachment to opposite sides of a wearer's waist belt, a generally open holster assembly, mounted at the end portion of said elastic band proximate said first clamp buckle for supporting and retaining a box-like article against the wearer's chest, said holster assembly formed by a belt loop of the holster belt; at least one elastic loop strip being transversely mounted to an intermediate section of said belt loop to accommodate and releasably retain against accidental release said box-like article.

D. Prior art U.S. Pat. No. 6,695,187 by Dunkle and issued in 2004 for a Portable radio carrying case. A carrying case for a portable two-way radio and designed to be attached to various points or straps on a Type V floatation vest used as a work vest by crew members on tugboats, tow boats and other inland or intra-coastal waterway vessels. The carrying case is comprised of a receptacle and strap. The receptacle is formed of a flexible material and has an open top and front, rear, bottom and two side surfaces. The strap is mounted longitudinally to the rear surface, and passes through a D-ring attached to the top edge of the front surface. The strap has fastening means on either end for securing the two ends together. The case is then attached to a work vest by passing the strap through an attachment point on the work vest above the case, then through another attachment point below the case. The ends of the strap are then tightened by the fastener means. In so tightening, the strap cinches the D-ring and the top edge of the front surface against the top edge of the rear surface, forming a closure of the receptacle.

E. U.S. Ser. No. 10/003,369 by Ooi et al issued in 2018 for a Portable, wearable radio. A portable, wearable radio includes a modular harness having the flexibility to be reconfigured into a plurality of different profiles, the modular harness having an interior and a plurality of radio components removably disposed within the interior of the modular harness. The plurality of radio components includes a first radio component, a second radio component electrically coupled to the first radio component via a first flexible electrical connector, and a third radio component electrically coupled to the first radio component via at least one of a group selected from the first flexible electrical connector and a second flexible electrical connector.

F. Prior art U.S. Ser. No. 11/183,318 by Shroyer and issued in 2023 for a Fire retardant, releasably connectable wrap for a portable radio, remote speaker microphone, and the cord therebetween. Wraps that provide heat and flame resistant properties to a portable radio, a remote speaker microphone (RSM), and a cord therebetween have an elongate body having a head and a tail, opposing first and second major surfaces that each have first and second elongate edges, and first and second elongate sides. The elongate body is made of flame and heat resistant fabric and has first fasteners positioned as a releasably makeable pair when the first and second elongate sides meet or overlap in a wrapped positioned. The head defines an opening therethrough positioned for alignment with a voice amplifier of a RSM when the wrap is in a wrapped position around the RSM. A wrap may be and independent article or it may be sewn to a firefighter turnout coat on a front boy section proximate a neck section of the coat.

G. Prior art U.S. Ser. No. 11/712,103 by Altschul et al and issued in 2023 for an Apparatus for carrying objects with a mobile communications device. Embodiments of the present invention are directed to an apparatus for carrying objects with a mobile communications device. In one embodiment, the apparatus includes a protective case adapted to receive a mobile communications device. The apparatus includes a carrying strap fastened to the protective case. The apparatus includes one or more loops disposed on the carrying strap. The one or more loops are adapted to receive an elongated object and hold the elongated object in a fixed position with respect to the carrying strap. In an alternative embodiment, the apparatus includes one or more pockets adapted to receive credit-card sized items. The apparatus includes a closeable flap. The apparatus includes one or more rings, each ring adapted to receive a clasp from a carrying strap. The apparatus includes an adhesive layer.

H. US20030188374A1 by Clifton and abandoned for a Strap mounted pocket member. A suspender system is disclosed that has a pocket for receiving items integrated with a shoulder pad used in the suspender system. The integrated pocket is constructed to enable the wearer to place items within the pocket without looking and to avoid placing an item between the pocket and a strap to which the shoulder pad is attached. Further disclosed is a display system to secure the clips on the suspender so that they do not become entangled with other items when the suspenders are displayed for sale.

I. US20160081446A1 by Maddox et al written in 2015 for a Wearable remote speaker mic holder, radio support, and system comprising the same. User-wearable remote speaker mic (RSM) holders for positioning a remote speaker mic relative to the mouth of the wearer are disclosed as well as a wearable radio support system including the same. The RSM holders include an elongate body having a first end and a second end and a first major side extending from the first end to the second end, and RSM attachment member position able along the length of the first major side. The first end of the elongate body is releasably attachable to or is permanently attached to a donnable article of clothing or donnable gear, and a first attachment member is positioned at or proximate the second end of the elongate body and is connectable to a feature of the donnable article of clothing and/or the donnable gear.

J. U.S. Ser. No. 10/972,144B2 by January et al issued 2021 Communication systems with body worn plate design. Systems and methods for operating a communication device. The methods comprise: concealing the communication device and/or at least one cable in a ballistic wearable item (e.g., a ballistic vest) such that the communication device resides in a storage slot for a trauma plate, where the communication device comprises a frame having a cross-sectional profile that matches a cross-sectional profile of the trauma plate by a given amount (e.g., 75-100%); and performing communication operations by a radio module integrated with the frame of the communication device.

As can be observed, none of the prior art has anticipated or caused one skilled in the portable radio or carrier units to see this unique Hi-Def Radio Strap System as obvious to one skilled in the industry. The Hi-Def Radio Strap System provides an answer to a first responder to avoid all the problems mentioned above as well as the advantages listed below in an efficient manner.

### SUMMARY OF THE INVENTION

A radio strap must meet various requirements for the individual to deem it a suitable product for them to use to aid in their successful job and/or duty performance. The radio strap system shall include any of the following parts in a defined combination to secure and carry the radio: radio bucket, radio strap, tail strap, anti-sway strap, and mic loops. The Hi-Def Radio Strap System is a portable radio carrying system attached to a main strap and manufactured with abrasion resistant and fire-retardant materials. The radio bucket is made of fabric and formed into a shape suitable for insertion and protection of a portable radio; attachment hardware secures the shape and permits for the attachment of other accessories (like a microphone, camera prying tools, small bottle of oxygen, a water bottle, flashlight and the like) to the radio strap and bucket; this system surrounds the portable radio to prevent radio from being easily dislodged from the radio bucket. The radio strap system includes a radio tail connected to the main radio strap by a belt buckle style attachment member. This allows for adjustability of the length of the radio strap plus provides an attachment member at either end of the radio strap as a rotatable, quick-release design.

The radio bucket is composed of one or more pieces of fabric to form a shape suitable for a radio to fit into the opening and be held in place by a radio hold down secured with a fastener. The radio strap is composed of one or more pieces of material to form a strap in various lengths. This strap may be utilized as the wearable portion of the radio strap and can be equipped with adjustable hardware or material for the individual to adjust the overall length by various dimensions. The radio strap can have one or more mic loops attached to the middle section of the strap for attachment of the radio microphone or other items not associated with the radio.

The preferred embodiment of the Hi-Def Radio Strap System is a wearable and portable radio carrying system called a Hi-Def Radio Strap System, made of a durable material, and comprised of: (a) a radio bucket comprising (i) at least one piece of fabric configured and forming a shape suitable for a portable radio to be inserted into the radio bucket which protects at least one side of the portable radio by covering the portable radio with the above mentioned fabric; an amount of attachment hardware that is required to keep the above mentioned shape and to allow for attaching of other items to the radio bucket; and (iii) a component to partially encase the portable radio and prevent the radio from being dislodged from the radio bucket; (b) An encircling strap comprising: (i) a main radio strap made of durable materials and firstly having one end with a removable means for attaching the main radio strap to the radio bucket at a securing loop dee ring, secondly having an opposite end with a set of linear apertures for securing the opposite end to a belt buckle and a prong attachment means, thirdly having a middle section of the encircling strap with a removable panel which provides a pre-selected ultra violet design and an attachment means for removably securing the removable panel to the middle section 37 of the main radio strap, and lastly having mic loops for attaching mics and other accessories; and (c) A tail strap connected to the main radio strap 30 at one end by way of the belt buckle and prong style attachment means which allows for adjustability of the length of the combination main radio strap 30 and the tail strap and which allows for, at an opposite end of the tail strap, having a removable means for attaching the tail strap to the radio bucket at a securing loop dee ring wherein the radio carrying system helps firefighters, first responders, defense personnel and others to always keep aware of the location of their radio and is a re-useable base radio strap that can be modified if the user changes locations, changes affiliation with a certain department, and changes in a title or rank of the user.

### Objects and Advantages

There are several objects and advantages of the Hi-Def Radio Strap System. These various advantages and benefits that help the first responders, emergency, and other professionals include:

| Item | Advantages |
|---|---|
| 1 | Unlimited customization for better identification |
| | including colors, font, logos |
| 2 | Interchangeable identification panel |
| 3 | Adjustable sizing |
| 4 | Resilient and longer lasting print versus paint or |
| | transfer process |
| 5 | Re-useable base radio strap if user changes |
| | locations, affiliation with department, or changes |
| | title |
| 6 | Immediate use once UV print is cured |

Finally, other advantages and additional features of the present Hi-Def Radio Strap System will be more apparent from the accompanying drawings and from the full description of the device. For one skilled in the art of innovative radio systems and the accessories used to transport them with the individual user, it is readily understood that the features shown in the examples with this product can be adapted to other types of radio accessories and carrier straps and the like.

### DESCRIPTION OF THE DRAWINGS—FIGURES

The accompanying drawings, which are incorporated in and constitute a part of this specification, illustrate an embodiment of the Hi-Def Radio Strap System. The drawings together with the summary description given above and a detailed description given below help to explain the principles of the Hi-Def Radio Strap System. It is understood, however, that this Hi-Def Radio Strap System is not limited to only the precise arrangements and instrumentalities shown.

FIGS. 1 A and 1 B are sketches of the general radio strap 30 for removably securing a two-way portable radio 95 by and on a user/firefighter 100 and a view 90 of all the components that comprise a radio strap 30.

FIG. 2 is a sketch of the general radio strap 30 for removably securing a two-way portable radio 95 by and on a user/firefighter 100 with components and features noted.

FIG. 3 is a sketch of the view 90 of all the components that comprise a radio strap 30 with the components and features shown from generally a top view.

FIG. 4 is a sketch of key components of the radio strap 30 with an enlarged view of some of the key components that comprise a radio strap 30.

FIG. 5 is a sketch of the main strap section 93 of the radio strap 30 for removably securing a two-way portable radio and the removable panel system 60 is removably attached.

FIG. 6 is a listing of the process 88 used for placing the UV printing identification 99 on the removable panel system 60 of the radio strap 30.

FIGS. 7 A through 7 D are sketches of Prior Art in the field of radio belts and applying designs thereon.

### DESCRIPTION OF THE DRAWINGS—REFERENCE NUMERALS

The following list refers to the drawings:

TABLE B
Reference numbers -

| Item | Description |
|---|---|
| 30 | Hi-Def Radio Strap System 30 for removably securing |
| SYS | a two-way portable radio 95 by and on a user/ |
| | firefighter 100 |
| 30 | Main radio strap 30 for removably securing a two-way |
| | portable radio 95 by and on a user/firefighter 100, |
| | this radio strap 30 includes a connection end 31A |
| | for attaching to a radio bucket 51 and an opposite |
| | end 31 with notches/apertures 38 for attaching to |
| | the radio bucket end 31A of the tail strap 34 |
| 31 | Notch/aperture end 31 of the main radio strap 30 |
| | where aperture/notches 38 are located at an |
| | opposite end 31A from a radio bucket 51 end |
| 31A | Radio bucket end 31A of the main radio strap 30 |
| 32 | Roller buckle 32 with a frame 39 and a bar 39A plus |
| | a prong 33, all being co-located at one end of a |
| | tail strap 34 and configured in the system 30SYS to |
| | engage the apertures 38 located linearly at the end |
| | of the notch/aperture end 31 of the main radio |
| | strap 30 |
| 33 | prong 33 of the Tail strap 34 located at the buckle |
| | 32 end of said tail strap 34 and rotationally |
| | secured to the roller buckle 32B at the frame 39 and |
| | bar 39A, (note that said prong 33 can uniquely |
| | engage the notches/holes/apertures 38 of the main |
| | radio strap 30 for adjusting the length of the Hi- |
| | Def Radio Strap System 30 by adjusting the location |
| | of where the prong 33 of the tail strap 34 engages |
| | the notches/apertures of the main radio strap 30 |
| 34 | Tail strap 34 with a buckle 32 at one end to attach |
| | with the notches/apertures 38 of the main radio |
| | strap 30 and with a removable means or member 47A |
| | for attaching to the dee rings 57 at the opposite |
| | end of the tail strap 34 the dee rings 57 are part |
| | of the radio bucket 51 |
| 35 | stamped logo 35 on the radio strap 30 located at the |
| | tip of the notch/aperture end 31 of main radio strap 30 |
| 36 | mic loops 36 that can be used for securing |
| | accessories such cameras, mics, flashlights, oxygen |
| | source, water, medical supplies, food, and various |
| | small extraction tools |
| 37 | middle section 37 of the main radio strap 30 whereby |
| | the removable panel system 60 is removably attached |
| | to the main radio strap 30 |
| 38 | notch/aperture/holes/slit 38 of the main radio |
| | strap 30, wherein these apertures 38 are configured |
| | in a linearly-spaced location at the notched/ |
| | aperture end 31A of the main radio belt 30 |
| 39 | frame 39 and bar 39A components of the roller buckle |
| | 32 |
| 40 | anti-sway strap 40 made of sub-components and having |
| | two ends to the strap 40 |
| 41 | means 41 for securing the sub-components of the |
| | anti-sway strap 40 such as stitching, adhesive, |
| | rivets, snaps, hook and loop, or the like |
| 47 | removable means or member 47 for attaching at one |
| | end of the anti-sway strap 40 (such as spring-loaded |
| | clasp and loop, hook and eye, and the like) to the |
| | radio bucket 51 at a securing “Dee Ring”, loop 57 |
| 47A | removable means or member 47A for attaching at one |
| | end of the tail strap 34 (such as spring-loaded |
| | clasp and loop, hook and eye, and the like) to the |
| | radio bucket 51 at a securing loop 57 |
| 49 | removable means or member 49 for attaching the anti- |
| | sway 40 to a user's garment like a belt loop at an |
| | opposite end of the anti-sway strap 40 (such as |
| | spring-loaded clasp and loop, hook and eye, and the |
| | like) |
| 49A | removable means or member 49A for attaching (such as |
| | spring-loaded clasp and loop, hook and eye, and the |
| | like) the main radio strap 30 to the radio bucket 51 |
| | at a securing loop 57 |
| 51 | radio bucket 51 for removably encasing a portable |
| | radio 95 of the user/firefighter 100 |
| 52 | a hold down strap 52 for removably securing a radio |
| | 95 into the radio bucket 51 |
| 53 | attachment means 53 for securing the cord material |
| | 56 and one end of the hold down strap 52 to radio |
| | bucket 51 such as a snap, button, Velcro, hook and |
| | eye, sewn thread, small rivets, threaded fasteners, |
| | staples, adhesives and the like. This means for |
| | attachment 53 can be utilized throughout the system |
| | 30 SYS |
| 54 | attachment means 54 for securing the hold down strap |
| | 52 to the radio bucket 51 such as a snap, button, |
| | Velcro, hook and eye, or the like |
| 56 | cord material 56 for tethering the radio 95 to the |
| | anti-sway strap 40 |
| 57 | a set of securing loops 57 sometimes called “Dee |
| | Rings” on the radio bucket 51 for securing the |
| | removable means or members 49, 49A for attaching the |
| | radio bucket 51 to the main radio belt 30 and the |
| | tail 34 |
| 60 | removable panel system 60 where the Ultra Violet |
| | (UV) printing identification 99 is placed on the |
| | main radio strap 30 |
| 61 | attachment means 61 for removably securing the |
| | removable panel system 60 to the middle section 37 |
| | of the radio strap 30 such as a snap, button, |
| | Velcro, hook and eye, or the like (Snap parts shown |
| | are for cap and stud 61A and socket 61B) |
| 88 | a process 88 used for placing the UV printing |
| | identification 99 onto the removable panel system 60 |
| | of the radio strap 30 |
| 89 | design 89 for digital printing, said design |
| | comprised of a unique combination of words, logos |
| | and/or artwork |
| 90 | view 90 of all the components that comprise a radio |
| | strap system 30 SYS |
| 93 | the main strap section 93 of the radio strap system |
| | 30 for removably securing a two-way portable radio |
| | 99 |
| 95 | radio 95 (not shown), two-way radio for |
| | communication between firefighters, emergency |
| | personnel, and others using the radio strap 30 of |
| | the user/firefighter 100 |
| 99 | UV printing identification 99 |
| 100 | user/firefighter 100 |
| 700 | Prior art 700 U.S. Pat. No. 3,868,573 by Holcomb et al issued in |
| | 1975 for a Shoulder holster communication device |
| 710 | Prior art 710 U.S. Pat. No. 6,695,187 by Dunkle and issued in |
| | 2004 for a Portable radio carrying case |
| 720 | Prior art 720 U.S. Pat. No. 11,183,318 by Shroyer and issued in |
| | 2023 for a Fire retardant, releasably connectable |
| | wrap for a portable radio, remote speaker |
| | microphone, and the cord therebetween |
| 730 | Prior art 730 U.S. Pat. No. 11,712,103 by Altschul et al and |
| | issued in 2023 for an Apparatus for carrying objects |
| | with a mobile communications device |

### DETAILED DESCRIPTION OF PREFERRED EMBODIMENT

The present invention relates to the field of first responders, public servants or any profession or individual utilizing a portable radio with a corded or cordless microphone. Specifically, the present invention relates to first responders carrying two-way portable radios and a Hi-Def Radio Strap System. The present disclosure relates generally to communication systems. More particularly, the present disclosure relates to communication systems with body-worn radios for immediate communications during emergency situations.

The advantages for the Hi-Def Radio Strap System 30 are:
A. Unlimited customization for better identification including colors, font, logos;
B. Interchangeable identification panel;
C. Adjustable sizing;
D. Resilient and longer lasting print versus paint or transfer process;
E. Re-useable base radio strap if user changes locations, affiliation with department, or changes title; and
F. Immediate use once UV print is cured.

The preferred embodiment of the Hi-Def Radio Strap System is a wearable and portable radio carrying system 30SYS called a Hi-Def Radio Strap System, made of a durable material, and comprised of: (a) a radio bucket 51 comprising (i) at least one piece of fabric configured and forming a shape suitable for a portable radio 90 to be inserted into the radio bucket 51 which protects at least one side of the portable radio 95 by covering the portable radio with the above mentioned fabric; an amount of attachment hardware that is required to keep the above mentioned shape and to allow for attaching of other items to the radio bucket 51; and (iii) a component to partially encase the portable radio 95 and prevent the radio 95 from being dislodged from the radio bucket 51; (b) An encircling strap comprising: (i) a main radio strap 30 made of durable materials and firstly having one end 31A with a removable means 49A for attaching the main radio strap 30 to the radio bucket 51 at a securing loop dee ring 57, secondly having an opposite end 31 with a set of linear apertures 58 for securing the opposite end 31 to a belt buckle 32 and a prong 33 attachment means, thirdly having a middle section 37 of the encircling strap with a removable panel 60 which provides a pre-selected ultra violet design 99 and an attachment means 61 for removably securing the removable panel 60 to the middle section 37 of the main radio strap 30, and lastly having mic loops 36 for attaching mics and other accessories; and (c) A tail strap 34 connected to the main radio strap 30 at one end by way of the belt buckle 32 and prong 33 style attachment means which allows for adjustability of the length of the combination main radio strap 30 and the tail strap 34 and which allows for, at an opposite end of the tail strap 34, having a removable means 47A for attaching the tail strap 34 to the radio bucket 51 at a securing loop dee ring 57 wherein the radio carrying system 30SYS helps firefighters, first responders, defense personnel and others to always keep aware of the location of their radio and is a re-useable base radio strap that can be modified if the user changes locations, changes affiliation with a certain department, and changes in a title or rank of the user.

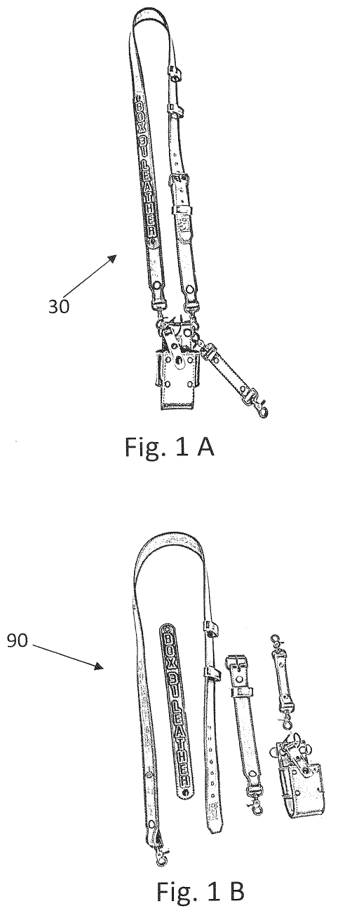

There is shown in FIGS. 1-7 a complete description and operative embodiment of the Hi-Def Radio Strap System. In the drawings and illustrations, one notes well that FIGS. 1-7 demonstrate the general configuration and use of this product. The operation and use section, below, describes how it is installed with the patient. The accompanying drawings, which are incorporated in and constitute a part of this specification, illustrate an embodiment of the Hi-Def Radio Strap System 30. The drawings together with the summary description given above and a detailed description given below explain the principles of the Hi-Def Radio Strap System 30 for use by firefighters and others carrying and caring for a two-way radio. It is understood, however, that the system 30 is not limited to only the precise arrangements and instrumentalities shown. Other examples for using the device and their uses are still understood by one skilled in the art of using two-way portable radios in emergency service situations to be within the scope and spirit shown here.

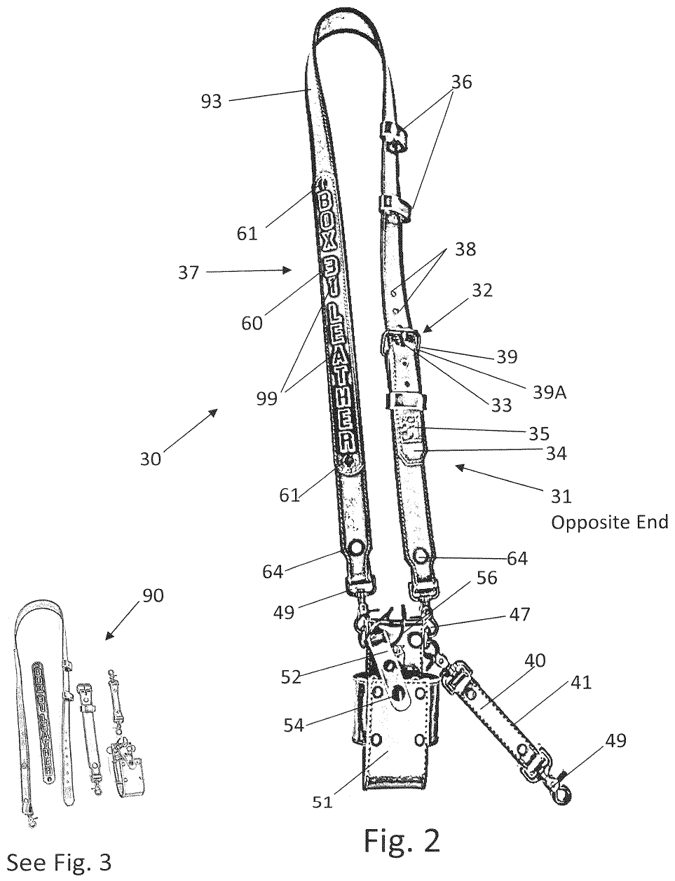

FIGS. 1A and 1 B when accompanied with FIG. 2 illustrates a radio strap 30 in conjunction with a tail strap 34 to assemble a strap system 30SYS that will connect to a radio bucket 51 and anti-sway strap 40. All of these item's strap portion is any fabric material in the depicted shapes to form the item. The radio bucket 51 will be utilized to carry a portable two-way radio 95 that utilizes an external microphone (not shown here). The radio bucket 51 is assembled with attachment members 61 and 54 to form the shape that will hold the portable radio 95. The radio 95 is secured in place in the radio bucket 51 by a hold down 52. The hold down 52 for the radio 95 is assembled using attachment member 53 to around a piece of cord material 56. The cord 56 as well as the radio bucket 51 use a set of Dee Rings or the like to attach the attachment members 47, 47A, 49, 49A. The hold down strap 52 has an attachment member 54 affixed to it to secure to the radio bucket 51. The radio bucket is assembled with attachment members 47 for additional add-ons such as an anti-sway strap 40, tail 35 or radio strap 30. Anti-sway strap 40 uses attachment members 53 and 49 and is secured to the radio bucket 51 attachment member 47 with attachment member 49. The anti-sway strap 40 can then be tethered to any part of the individual's 100 body or accessories.

The radio strap 30 is composed by utilizing attachment members 47, 47A, 49, 49A, 53, and 54 to form the entire radio strap system 30SYS that will be used to form the loop shape to drape or hang over the individual or accessories. The radio strap 30 SYS utilizes mic loops 36 for attachment of the radio phone microphone and other accessories (other accessories like a microphone, camera prying tools, small bottle of oxygen, a water bottle, flashlight and the like) and are attached to the radio strap 30 by attachment members 53. The radio tail 34 portion of the radio strap system 30SYS is composed by utilizing attachment members 65 and 32. The roller buckle 32 allows for adjustment of the overall length of the radio strap 30. The tail strap 34 also has a mic loop 36 to secure the excess fabric of the radio strap 30.

Identification of the individual wearing the radio strap 30 is accomplished by way of a removable panel system 60. This removable panel system 60 can be composed of the same or different fabric as the adjoining pieces and is attached to the radio strap 30 by utilizing attachment members 54. The identification is applied by using the UV printing identification 99 to the removable panel system 60 or to any other portion of the device mentioned above.

FIGS. 1 A and 1 B are sketches of the general radio strap 30 for removably securing a two-way portable radio 95 by and on a user/firefighter 100 and a view 90 of all the components that comprise a radio strap 30. Indicated in these overview drawings are: a radio strap 30 for removably securing a two-way portable radio 95 by and on a user/firefighter 100 and a view 90 of all the components that comprise a radio strap 30.

FIG. 2 is a sketch of the general radio strap system 30SYS for removably securing a two-way portable radio 95 by and on a user/firefighter 100 with components and features noted. Shown in these drawings are: a main radio strap system 30SYS for removably securing a two-way portable radio 95 by and on a user/firefighter 100; a notch end 31 of a main radio strap 30 where aperture/notches 38 are linearly located; an opposite end 31A where there is a removable means or member 49A for attaching (the means can be such as spring-loaded clasp and loop, hook and eye, and the like) the main radio strap 30 to the radio bucket 51 at a securing Dee ring or securing loop 57; an attachment member and roller buckle 32 and one end of the tail strap 34; a prong 33 of the trail strap 34 which engages the notches/holes/apertures 38 at the notches/aperture end 31 of the main radio strap 30 for removably securing the ends 31, 31A of the main radio strap 30 to the tail strap 34 and form an adjustable loop; a tail strap 34 or end of the one end of the radio strap 30 where the notches 38 are located; a stamped logo 35 on the radio strap 30 located at the tip of the notch end 31 of radio strap 30; at least one mic loops 36; a middle section 37 of the radio strap 30 where the removable panel system 60 is removably attached; an aperture/notches 38 of the radio strap 30; a frame 39 and bar 39A of the roller buckle 32; an anti-sway strap 40 made of sub-components and having two ends to the strap 40; a means 41 for securing the sub-components of the anti-sway strap 40 such as stitching, adhesive, rivets, snaps or the like; a removable means or member 47 for attaching at one end of the anti-sway strap 48 such as spring-loaded a clasp and loop, hook and eye, and the like; a removable means or member 49 for attaching at an opposite end of the anti-sway strap 48 such as spring-loaded clasp and loop, hook and eye, and the like; a radio bucket 51 for removably encasing a portable radio 95 of the user/firefighter 100; a hold down strap 52 for removably securing a radio 95 into the radio bucket 51; an attachment means 53 for securing the hold down strap 52 to the radio bucket 51 such as a snap, button, Velcro, hook and eye, or the like; an attachment means 53 for securing the hold down strap 52 to the radio bucket 51 such as a snap, button, Velcro, hook and eye, sewn thread, small rivets, threaded fasteners, staples, adhesives and the like; a cord material 56 for tethering the radio 95 to the anti-sway strap 40; a removable panel system 60 where the UV printing identification 99 is placed on the main radio strap 30; an attachment means 61 for removably securing the removable panel system 60 to the middle section 37 of the radio strap 30 such as a snap, button, Velcro, hook and eye, or the like; an attachment means 54 for securing the ends of the radio strap 52 to the radio bucket 51 such as a snap, button, Velcro, hook and eye, or the like; a process 88 used for placing the UV printing identification 99 onto the removable panel system 60 of the radio strap 30; a view 90 of all the components that comprise a radio strap 30; a main strap section 93 of the radio strap 30 for removably securing a two-way portable radio 99; and a UV printing identification.

FIG. 2 is a sketch of the general radio strap 30 for removably securing a two-way portable radio 95 by and on a user/firefighter 100 with components and features noted. Shown in these drawings are: a radio strap 30 for removably securing a two-way portable radio 95 by and on a user/firefighter 100; a notch end 31 of radio strap 30 where aperture/notches 38 are located and at the opposite from a roller buckle 32 end; an attachment member and roller buckle 32 and one end of the radio strap 30; a prong 33 of the radio strap 30 which engages the notches/holes/apertures 38 for removably securing the ends 31, 32 of the radio strap 30 and forms an adjustable loop; a tail strap 34 or end of the one end of the radio strap 30 there the notches 38 are located; a stamped logo 99 on the radio strap 30 located at the tip of the notch end 31 of radio strap 30; at least one mic loops 36; a middle section 37 of the radio strap 30 where the removable panel system 60 is removably attached; an aperture/notches 38 of the radio strap 30; a frame 39 and bar 39A of the roller buckle 32; an anti-sway strap 40 made of sub-components and having two ends to the strap 40; a means 41 for securing the sub-components of the anti-sway strap 40 such as stitching, adhesive, rivets, snaps or the like; a removable means or member 47 for attaching at one end of the anti-sway strap 48 such as spring-loaded a clasp and loop, hook and eye, and the like; a removable means or member 49 for attaching at an opposite end of the anti-sway strap 48 such as spring-loaded clasp and loop, hook and eye, and the like; a radio bucket 51 for removably encasing a portable radio 95 of the user/firefighter 100; a hold down strap 52 for removably securing a radio 95 into the radio bucket 51; an attachment means 53 for securing the hold down strap 52 to the radio bucket 51 such as a snap, button, Velcro, hook and eye, or the like; an attachment means 54 for securing the hold down strap 52 to the radio bucket 51 such as a snap, button, Velcro, hook and eye, or the like; a cord material 56 for tethering the radio 95 to the anti-sway strap 40; a removable panel system 60 where the UV printing identification 99 is placed on the radio strap 30; an attachment means 61 for removably securing the removable panel system 60 to the middle section 37 of the radio strap 30 such as a snap, button, Velcro, hook and eye, or the like; an attachment means 54 for securing the ends of the radio strap 52 to the radio bucket 51 such as a snap, button, Velcro, hook and eye, or the like; a process 88 used for placing the UV printing identification 99 onto the removable panel system 60 of the radio strap 30; a view 90 of all the components that comprise a radio strap 30; a main strap section 93 of the radio strap 30 for removably securing a two-way portable radio 99; and a UV printing identification.

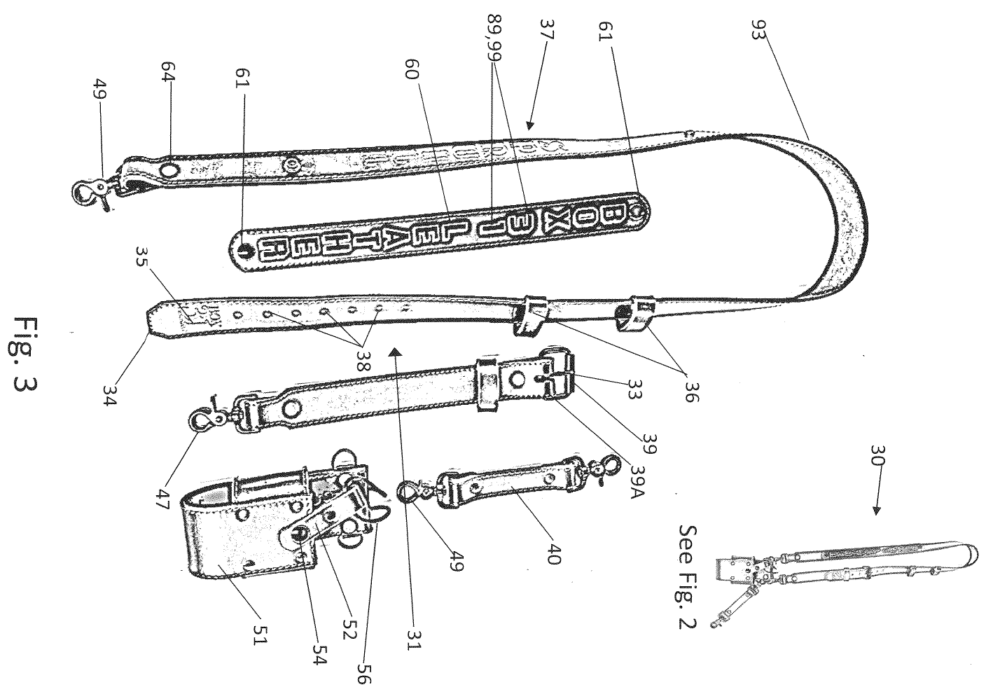

FIG. 3 is a sketch of the view 90 of all of the components that comprise a radio strap 30 with the components and features shown from generally a top view. Provided in these sketches are: a radio strap 30 for removably securing a two-way portable radio 95 by and on a user/firefighter 100; a notch end 31 of radio strap 30 where aperture/notches 38 are located and at the opposite from a roller buckle 32 end; an attachment member and roller buckle 32 and one end of the radio strap 30; a prong 33 of the radio strap 30 which engages the notches/holes/apertures 38 for removably securing the ends 31, 32 of the radio strap 30 and forms an adjustable loop; a tail strap 34 or end of the one end of the radio strap 30 there the notches 38 are located; a stamped logo 35 on the radio strap 30 located at the tip of the notch end 31 of radio strap 30; at least one mic loops 36; a middle section 37 of the radio strap 30 where the removable panel system 60 is removably attached; an aperture/notches 38 of the radio strap 30 for attaching to the notch/apertures 38 of the radio strap 30; a frame 39 and bar 39A of the roller buckle 32; an anti-sway strap 40 made of sub-components and having two ends to the strap 40; a removable means or member 47 for attaching at one end of the anti-sway strap 48 such as spring-loaded a clasp and loop, hook and eye, and the like; a removable means or member 49 for attaching at an opposite end of the anti-sway strap 48 such as spring-loaded clasp and loop, hook and eye, and the like; a radio bucket 51 for removably encasing a portable radio 95 of the user/firefighter 100; a hold down strap 52 for removably securing a radio 95 into the radio bucket 51; an attachment means 53 for securing the hold down strap 52 to the radio bucket 51 such as a snap, button, Velcro, hook and eye, or the like; an attachment means 54 for securing the hold down strap 52 to the radio bucket 51 such as a snap, button, Velcro, hook and eye, or the like; a cord material 56 for tethering the radio 95 to the anti-sway strap 40; a removable panel system 60 where the UV printing identification 99 is placed on the radio strap 30; an attachment means 61 for removably securing the removable panel system 60 to the middle section 37 of the radio strap 30 such as a snap, button, Velcro, hook and eye, or the like; an attachment means 54 for securing the ends of the radio strap 52 to the radio bucket 51 such as a snap, button, Velcro, hook and eye, or the like; a design 89 for digital printing, said design comprised of an unique combination of words, logos and/or artwork; a view 90 of all the components that comprise a radio strap 30; a main strap section 93 of the radio strap 30 for removably securing a two-way portable radio 99; and a UV printing identification 99.

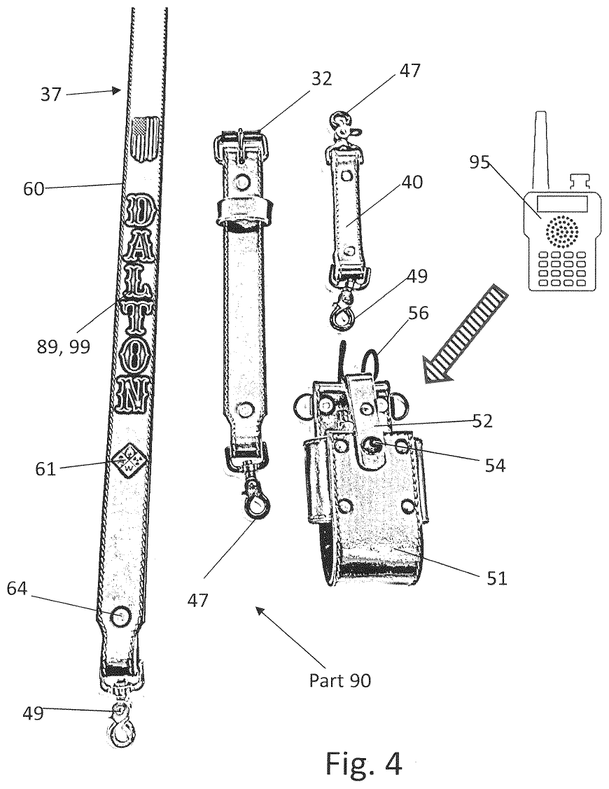

FIG. 4 is a sketch of key components of the radio strap 30 with an enlarged view of some of the key components that comprise a radio strap 30. Shown here are: an attachment member and roller buckle 32 and one end of the radio strap 30; an anti-sway strap 40 made of sub-components and having two ends to the strap 40; a removable means or member 47 for attaching at one end of the anti-sway strap 40 such as spring-loaded a clasp and loop, hook and eye, and the like; a removable means or member 49 for attaching at an opposite end of the anti-sway strap 48 such as spring-loaded clasp and loop, hook and eye, and the like; a radio bucket 51 for removably encasing a portable radio 95 of the user/firefighter 100; by a hold down strap 52 for removably securing a radio 95 into the radio bucket 51; a cord material 56 for tethering the radio 95 to the anti-sway strap 40; a removable panel system 60 where the UV printing identification 99 is placed on the radio strap 30; an attachment means 61 for removably securing the removable panel system 60 to the middle section 37 of the radio strap 30 such as a snap, button, Velcro, hook and eye, or the like; an attachment means 54 for securing the ends of the radio strap 52 to the radio bucket 51 such as a snap, button, Velcro, hook and eye, or the like; a design 89 for digital printing, said design comprised of an unique combination of words, logos and/or artwork; a view 90 of all the components that comprise a radio strap 30; a radio 95, two-way radio for communication between firefighters, emergency personnel, and others using the radio strap 30 of the user/firefighter 100; and a UV printing identification 99.

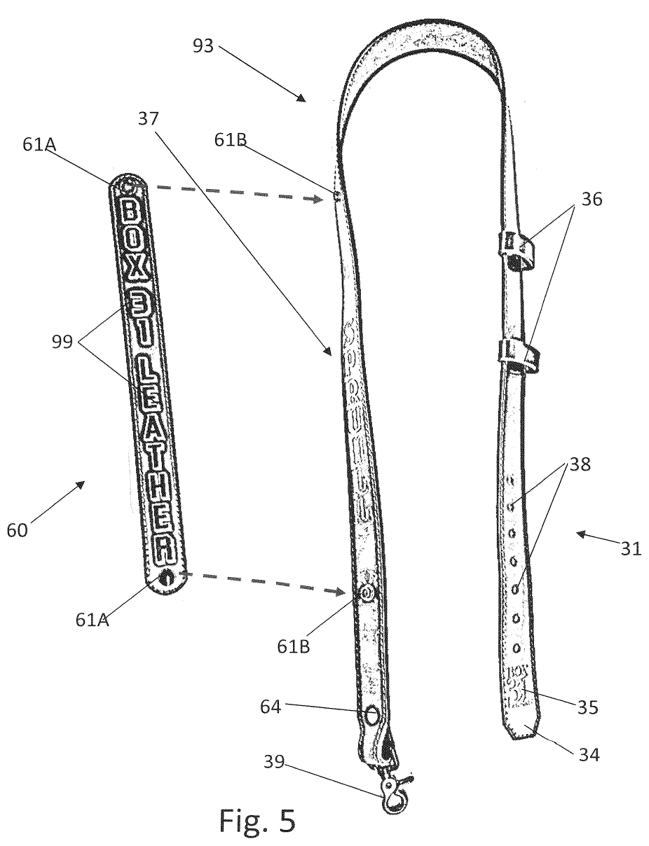

FIG. 5 is a sketch of the main strap section 93 of the radio strap 30 for removably securing a two-way portable radio and the removable panel system 60 is removably attached. an attachment member and roller buckle 32 and one end of the radio strap 30; a removable means or member 47 for attaching at one end of the anti-sway strap 48 such as spring-loaded a clasp and loop, hook and eye, and the like; a removable means or member 49 for attaching at an opposite end of the anti-sway strap 40 such as spring-loaded clasp and loop, hook and eye, and the like (attaching to the user at convenient place like a belt buckle); a radio bucket 51 for removably encasing a portable radio 95 of the user/firefighter 100; a hold down strap 52 for removably securing a radio 95 into the radio bucket 51; a cord material 56 for tethering the radio 95 to the anti-sway strap 40; a removable panel system 60 where the UV printing identification 99 is placed on the radio strap 30; an attachment means 61 for removably securing the removable panel system 60 to the middle section 37 of the radio strap 30 such as a snap, button, Velcro, hook and eye, or the like (Snap parts shown are cap and stud 61A and socket 61B); an attachment means 64 for securing the ends of the radio strap 52 to the radio bucket 51 such as a snap, button, Velcro, hook and eye, or the like; a design 89 for digital printing, said design comprised of an unique combination of words, logos and/or artwork; a view 90 of all the components that comprise a radio strap 30; and a UV printing identification 99. Ultra-violet (UV) printing is a type of digital printing that makes use of ultra-violet light to dry or cure the ink as it gets printed on the surface. As the printer goes on to distribute the ink on the surface of a material, the Ultraviolet lights follow close behind, “drying” or “curing” the ink instantly. The drops are applied in lines below the printhead through the movement of the marking material. In the same step, high-intensity UV radiation cures the fluid. The material is not heated by this process, meaning that the resulting markings can be used immediately.

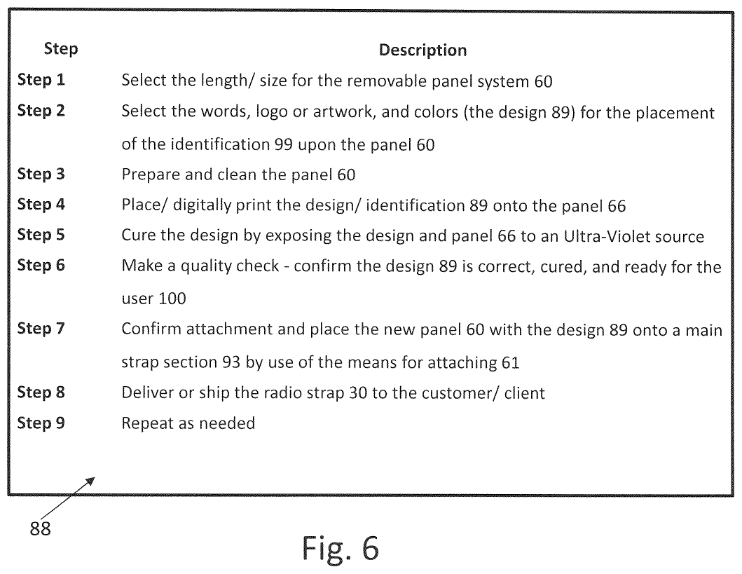

FIG. 6 is a listing of the process 88 used for placing the UV printing identification 99 on the removable panel system 60 of the radio strap 30. This is shown and discussed below in the operations section.

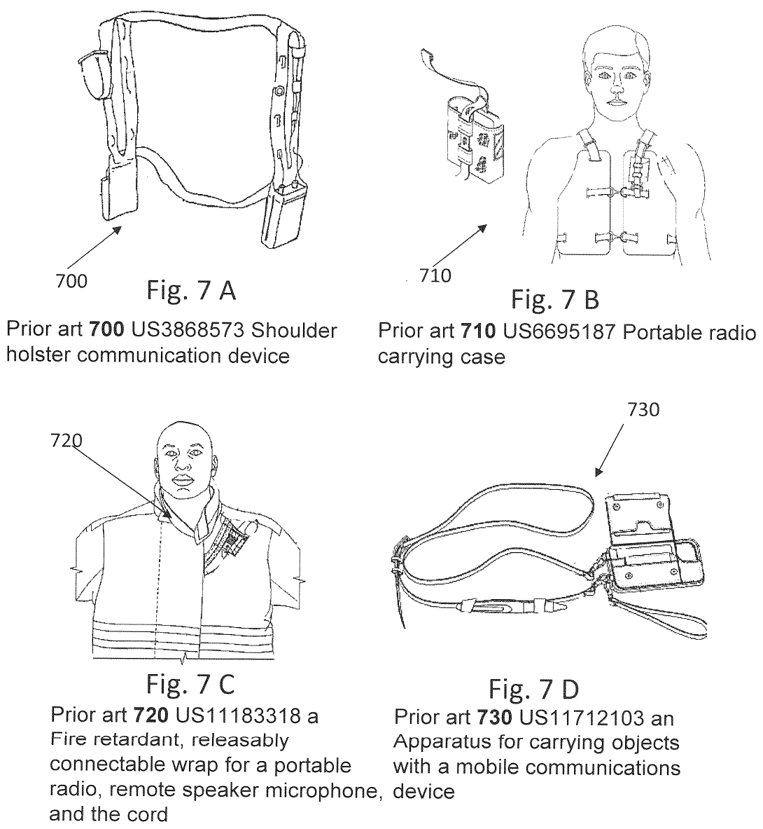

FIGS. 7 A through 7 D are sketches of Prior Art in the field of radio belts and applying designs thereon. These include: Prior art 700 U.S. Pat. No. 3,868,573 by Holcomb et al issued in 1975 for a Shoulder holster communication device; Prior art 710 U.S. Pat. No. 6,695,187 by Dunkle and issued in 2004 for a Portable radio carrying case; Prior art 720 U.S. Ser. No. 11/183,318 by Shroyer and issued in 2023 for a Fire retardant, releasably connectable wrap for a portable radio, remote speaker microphone, and the cord therebetween; and Prior art 730 U.S. Ser. No. 11/712,103 by Altschul et al and issued in 2023 for an Apparatus for carrying objects with a mobile communications device. As can be seen, the Hi-Def Radio Strap System 30 for use by firefighters with hi def radios are a unique medical device with the advantages shown above.

The fabric materials and components shown for the Hi-Def Radio Strap System 30 include fire and abrasion resistant material, readily disconnected connections, and fasteners such as a snap, and have quick release connections where possible. Fire retardant and Abrasion resistant materials are required for the materials used in the hi def radio strap component parts and system. Quality leather and treated leather stand out. The ability of these materials to withstand high temperatures without igniting or melting is crucial in providing vital protection to individuals working in environments where fire hazards are prevalent. The self-extinguishing feature further enhances safety by minimizing the risk of sustained burns in case of accidental exposure to flames. Most Fire retardant (FR) clothing and accessories are made from material that is designed to be resilient to heat. Materials like Nomex, Kevlar, and Modacrylic have excellent flame-resistant qualities and are commonly used to make elements of FR garments. Treated cotton and nylon as a pre-woven fabric with a chemical flame retardant, treated one hundred percent rayon, Modacrylic is a synthetic fabric that is almost flame-resistant. Nomex is inherently flame retardant, and the FR feature would not be washed away and it would be permanently existing in the fabric. Kevlar is often used in protective clothing thanks to its strong fibers, but it also offers flame-resistant applications. It would be not only flame retardant but also blade cut resistant and abrasion resistant. When it comes to ensuring the safety and efficacy of fire resistant clothing materials, it is essential to adhere to specific standards and regulations that govern their production and use. These standards are put in place to guarantee that the materials meet stringent safety requirements, providing reliable protection against heat and flames. The National Fire Protection Association (NFPA) has established various standards for protective clothing, including NFPA 2112 for flame-resistant garments worn by industrial workers and NFPA 1971 for protective ensembles worn by firefighters. Compliance with these standards is crucial in certifying the quality and performance of flame-retardant (FR) clothing and accessories.

The details mentioned here are exemplary and not limiting. Other specific components and manners specific to describing a Hi-Def Radio Strap System 30 can be added as a person having ordinary skill in the field of the art of radio accessories, components, and related devices.

### Operation of the Preferred Embodiment

The preferred embodiment of the Hi-Def Radio Strap System is a wearable and portable radio carrying system 30SYS called a Hi-Def Radio Strap System, made of a durable material, and comprised of: (a) a radio bucket 51 comprising (i) at least one piece of fabric configured and forming a shape suitable for a portable radio 90 to be inserted into the radio bucket 51 which protects at least one side of the portable radio 95 by covering the portable radio with the above mentioned fabric; an amount of attachment hardware that is required to keep the above mentioned shape and to allow for attaching of other items to the radio bucket 51; and (iii) a component to partially encase the portable radio 95 and prevent the radio 95 from being dislodged from the radio bucket 51; (b) An encircling strap comprising: (i) a main radio strap 30 made of durable materials and firstly having one end 31A with a removable means 49A for attaching the main radio strap 30 to the radio bucket 51 at a securing loop dee ring 57, secondly having an opposite end 31 with a set of linear apertures 58 for securing the opposite end 31 to a belt buckle 32 and a prong 33 attachment means, thirdly having a middle section 37 of the encircling strap with a removable panel 60 which provides a pre-selected ultra violet design 99 and an attachment means 61 for removably securing the removable panel 60 to the middle section 37 of the main radio strap 30, and lastly having mic loops 36 for attaching mics and other accessories; and (c) A tail strap 34 connected to the main radio strap 30 at one end by way of the belt buckle 32 and prong 33 style attachment means which allows for adjustability of the length of the combination main radio strap 30 and the tail strap 34 and which allows for, at an opposite end of the tail strap 34, having a removable means 47A for attaching the tail strap 34 to the radio bucket 51 at a securing loop dee ring 57 wherein the radio carrying system 30SYS helps firefighters, first responders, defense personnel and others to always keep aware of the location of their radio and is a re-useable base radio strap that can be modified if the user changes locations, changes affiliation with a certain department, and changes in a title or rank of the user.

FIG. 6 is a listing of the process 88 used for placing the UV printing identification 99 on the removable panel system 60 of the radio strap 30.
A. Step 1: Select the length/size for the removable panel system 60;
B. Step 2: Select the words, logo or artwork, and colors (the design 89) for the placement of the identification 99 upon the panel 60;
C. Step 3: Prepare and clean the panel 60;
D. Step 4: Place/digitally print the design/identification 89 onto the panel 66;
E. Step 5: Cure the design by exposing the design and panel 66 to an Ultra-Violet wave source;
F. Step 6: Make a quality check—confirm the design 89 is correct, cured, and ready for the user 100;
G. Step 7: Confirm attachment and place the new panel 60 with the design 89 onto a main strap section 93 by use of the means for attaching 65;
H. Step 8: Deliver or ship the radio strap 30 to the customer/client; and
I. Step 9: Repeat as needed.

With this description it is to be understood that the Hi-Def Radio Strap System 30 is not to be limited to only the disclosed embodiment of product. The features of the present Hi-Def Radio Strap System 30 as an improved radio and accessories carrying system for emergency responders and firefighters are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. Various features and aspects of the disclosed embodiments can be combined with or substituted for one another to form varying modes of the disclosed inventions. Thus, it is intended that the scope of at least some of the present inventions herein disclosed should not be limited by the disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A wearable and portable radio carrying system (30SYS) called a Hi-Def Radio Strap System, made of a durable material, and comprised of:
a. a radio bucket (51) comprising:
i. at least one piece of fabric configured and forming a shape suitable for a portable radio (90) to be inserted into the radio bucket (51) which protects at least one side of the portable radio (95) by covering the portable radio with the above mentioned fabric;
ii. an amount of attachment hardware is required to keep above mentioned shape and to allow for attaching of other items to the radio bucket (51); and
iii. a component to partially encase the portable radio (95) and prevent the radio (95) from being dislodged from the radio bucket (51);
b. An encircling strap comprising:
i. a main radio strap (30) made of durable materials and firstly having one end (31A) with a removable means (49A for attaching the main radio strap (30) to the radio bucket (51) at a securing loop dee ring (57), secondly having an opposite end (31) with a set of linear apertures (58) for securing the opposite end (31) to a belt buckle (32) and a prong (33) attachment means, thirdly having a middle section (37) of the encircling strap with a removable panel (60) which provides a pre-selected ultra violet design (99) and an attachment means (61) for removably securing the removable panel (60) to the middle section (37) of the main radio strap (30), and lastly having mic loops (36) for attaching mics and other accessories; and
c. A tail strap (34) connected to the main radio strap (30) at one end by way of the belt buckle (32) and prong (33) style attachment means which allows for adjustability of the length of the combination main radio strap 30 and the tail strap (34) and which allows for, at an opposite end of the tail strap (34), having a removable means (47A) for attaching the tail strap (34) to the radio bucket (51) at a securing loop dee ring (57)
Wherein the radio carrying system (30SYS) helps firefighters, first responders, defense personnel and others to always keep aware of the location of their radio and is a re-useable base radio strap that can be modified if the user changes locations, changes affiliation with a certain department, and changes in a title or rank of the user.

2. The wearable and portable radio carrying system (30SYS) described in claim 1 wherein the durable material is an abrasion resistant and fire-retardant material.

3. The wearable and portable radio carrying system (30SYS) described in claim 2 wherein the abrasion resistant and fire-retardant material is selected from the group consisting of quality leather, treated leather, Nomex®, Kevlar®, Modacrylic, treated cotton, treated nylon, and treated rayon.

4. The wearable and portable radio carrying system (30SYS) described in claim 1 wherein the attachment hardware for retaining the radio box (51) is selected from the group a cord material (56) for tethering, a snap, a button, a Velcro® component, and a hook and eye.

5. The wearable and portable radio carrying system (30SYS) described in claim 1 wherein the component to partially encase the portable radio (95) and prevent the radio (95) from being dislodged is a cord (56) and a hold down strap (52).

6. The wearable and portable radio carrying system (30SYS) described in claim 1 wherein the removable means (49A) for attaching the main radio strap (30) to the radio bucket (51) at a securing loop dee ring (57) is selected from the group consisting of a spring-loaded clasp and loop and a hook and eye.

7. The wearable and portable radio carrying system (30SYS) scribed in claim 1 wherein the attachment means (61) for removably securing the removable panel (60) to the middle section (37) of the main radio strap (30) is selected from the group consisting of a snap, a button, a Velcro® component, and a hook and eye component.

8. The wearable and portable radio carrying system (30SYS) escribed in claim 1 wherein the mic loops (36) can be used for securing accessories wherein the accessory is selected from the group consisting of cameras, mics, flashlights, oxygen, water, medical supplies, small extraction and cutting tools and food.

9. The wearable and portable radio carrying system (30SYS) escribed in claim 1 wherein the removable means (47A) for attaching the tail strap (34) to the radio bucket (51) at a securing loop dee ring (57) is selected from the group consisting of a spring-loaded clasp and loop, a hook and eye, and a Velcro RTM component.

10. The wearable and portable radio carrying system (30SYS) described in claim 1 further comprised with an anti-sway strap. (40).

11. A wearable and portable radio carrying system (30SYS) called a Hi-Def Radio Strap System, made of a durable material, and comprised of:
a. a radio bucket (51) comprising:
i. at least one piece of fabric configured and forming a shape suitable for a portable radio (90) to be inserted into the radio bucket (51) which protects at least one side of the portable radio (95) by covering the portable radio with the above mentioned fabric;
ii. an amount of attachment hardware required to keep above mentioned shape and to allow for attaching of other items to the radio bucket (51); and
iii. a component to partially encase the portable radio (95) and prevent the radio (95) from being dislodged from the radio bucket (51);
b. An encircling strap comprising:
i. a main radio strap (30) made of durable materials and firstly having one end (31A) with a removable means (49A) for attaching the main radio strap (30 to the radio bucket (51) at a securing loop dee ring (57), secondly having an opposite end (31) with a set of linear apertures (58) for securing the opposite end (31) to a belt buckle (32) and a prong (33) attachment means, thirdly having a middle section (37) of the encircling strap with a removable panel (60) which provides a pre-selected ultra violet design (99) and an attachment means (61) for removably securing the removable panel (60) to the middle section (37) of the main radio strap (30), and lastly having mic loops (36) for attaching mics and other accessories; and
c. A tail strap (34) connected to the main radio strap (30) at one end by way of the belt buckle (32) and prong (33) style attachment means which allows for adjustability of the length of the combination main radio strap (30) and the tail strap (34) and which allows for, at an opposite end of the tail strap (34), having a removable means (47A) for attaching the tail strap (34) to the radio bucket (51) at a securing loop dee ring (57); and
d. an anti-sway strap (40) with a spring-loaded clasp and loop at each end of the anti-sway strap (40)
wherein the radio carrying system (30SYS) helps firefighters, first responders, defense personnel and others to always keep aware of the location of their radio and is a re-useable base radio strap that can be modified if the user changes locations, changes affiliation with a certain department, and changes in a title or rank of the user.

12. The wearable and portable radio carrying system (30SYS) described in claim 11 wherein the durable material is an abrasion resistant and fire-retardant material.

13. The wearable and portable radio carrying system (30SYS) described in claim 12 wherein the abrasion resistant and fire-retardant material is selected from the group consisting of quality leather, treated leather, Nomex®, Kevlar®, Modacrylic, treated cotton, treated nylon, and treated rayon.

14. The wearable and portable radio carrying system (30SYS) described in claim 11 wherein the attachment hardware for retaining the radio box (51) is selected from the group a cord material (56) for tethering, a snap, a button, a Velcro® component, and a hook and eye.

15. The wearable and portable radio carrying system (30SYS) described in claim 11 wherein the component to partially encase the portable radio (95) and prevent the radio (95) from being dislodged is a cord (56) and a hold down strap (52).

16. The wearable and portable radio carrying system (30SYS) described in claim 11 wherein the removable means (49A) for attaching the main radio strap (30) to the radio bucket (51 at a securing loop dee ring (57) is selected from the group consisting of a spring-loaded clasp and loop and a hook and eye.

17. The wearable and portable radio carrying system (30SYS) described in claim 11 wherein the attachment means (61) for removably securing the removable panel (60) to the middle section (37) of the main radio strap (30) is selected from the group consisting of a snap, a button, a Velcro® component, and a hook and eye component.

18. The wearable and portable radio carrying system (30SYS) described in claim 11 wherein the mic loops (36) can be used for securing accessories wherein the accessory is selected from the group consisting of cameras, mics, flashlights, oxygen, water, medical supplies, small extraction and cutting tools and food.

19. The wearable and portable radio carrying system (30SYS) described in claim 11 wherein the removable means (47A) for attaching the tail strap (34) to the radio bucket (51) at a securing loop dee ring (57) is selected from the group consisting of a spring-loaded clasp and loop, a hook and eye, and a Velcro® component.
